(19) United States
(12) Patent Application Publication
(10) Pub. No.: US 2009/0070203 A1
(43) Pub. Date: Mar. 12, 2009

(54) SYSTEM AND METHOD FOR ONLINE ALLOCATION OF PERKS

(76) Inventors: Karen Orosco, Raymore, MO (US); Belinda Lower, Lenexa, KS (US); Douglas Tapp, Overland Park, KS (US); Mike McDaniel, Prairie Village, KS (US); Roger Dickson, Paola, KS (US); Julie Robinson, Kansas City, MO (US); Tammy Serati, Overland Park, KS (US)

Correspondence Address: HUSCH BLACKWELL SANDERS LLP, 4801 Main Street, Suite 1000, KANSAS CITY, MO, 64112, US

(21) Appl. No.: 11/852,037

(22) Filed: Sep. 7, 2007

(51) Int. Cl. G06Q 10/00; G06Q 30/00

(52) U.S. Cl. 705/14

(57) ABSTRACT

A method and system are disclosed for providing employees with amenities administered by an employer organization. The method and system include providing a quantity of perk credits to a user having a unique user id, presenting several perks to the user, where each of the plurality of perks is associated with a fee, receiving one or more perk selections from the user, where each of the one or more perk selections includes at least one perk from the plurality of perks, combining the fees associated with the one or more perk selections to determine a selected perk fee, and storing the one or more perk selections with the unique user id if the selected perk fee does not exceed the quantity of perk credits provided to the user.

### CROSS-REFERENCE TO RELATED APPLICATIONS

None.

### BACKGROUND OF THE INVENTION

A common priority for employers concerns recruiting and retaining key employees. One reason for this is that the time and expense associated with training and recruiting key employees frequently involves a considerable investment on the part of the employer. Accordingly, it is necessary for a company to retain employees in order for an employer to realize the benefits of employee investment. In some cases, a company will lose money every time an employee leaves the company.

One approach employers have taken in order to retain employees is to offer “amenities/perks” to employees. The goal of an amenities program is to ensure an employer retains quality employees/associates by offering benefits and services that are of value to the employee/associate. One of skill in the art will appreciate that there is an important distinction between a perks and qualified benefits. A “perk” is commonly understood to mean a benefit given to an employee in addition to a salary. On the other hand, examples of qualified benefits include health care, vision and dental care, group-term life insurance, disability, and adoption assistance.

It will be appreciated that in addition to a company's primary motivation (to attract and retain employees) there are a number of additional reasons for companies to offer employee perks. While one reason that, companies provide perks is to motivate employees and encourage loyalty to the company. Other reasons for company perks include enhancement of a company's corporate image as offering perks demonstrate that a company is generous and/or employee focused. Additionally, some companies provide perks as a performance based reward system in an effort to provide incentives for employee efforts.

Simply providing perks to employees is not enough to ensure high levels of employee retention* The kinds of perks that are offered by the employer and how perks are distributed send a message to existing and potential employees about the values of a company, it will be appreciated that: the time and monetary expense associated with a perks program represents yet another company investment in its employees.

Administration of an amenities program is often labor intensive. For example, many companies record employee amenity selections on paper forms which are later manually entered into a word processing document or spreadsheet. The resources dedicated by employers to paper form based systems are non-trivial. Paper form based systems are error prone due to data entry errors that occur while transcribing information from paper forms into an electronic document. Additionally, paper forms do not provide any way for an employee's amenity selections to he validated prior to submission of the form.

Naturally, employers offer perks programs in hopes of realizing some rate of return. Unfortunately, a paper based amenities program can make it difficult for an employer to monitor the program. In some cases, the expenses associated with providing perks are not even captured. Reporting on a paper based program can also he labor intensive. Accordingly, it may be difficult for an employer to get frequent or timely reports about certain aspects of the program or the overall status of the program in general. This tends to make it difficult for an employer to frequently and/or accurately determine whether or not the perks being offered are actually being used by employees, much less whether or not the company is receiving an acceptable rate of return its investment in the perks program.

Paper based systems are also susceptible to allowing invalid user selections which often require manual correction prior being processed. Another drawback is that administration of some systems is inefficient due to duplication of effort in paper form systems. The above mentioned issues may be especially challenging for a company with a single location and even more so for a national company with offices and employees based in several locations across the country.

Accordingly, in view of the above, mentioned problems present in existing perks/amenities programs, an improved perks program is needed.

### SUMMARY OF THE INVENTION

There is, therefore, provided in the practice of the invention a method for providing employees with amenities administered by an employer organization, including the steps of issuing a quantity of perk credits to a user where the user has a unique user id, presenting the user with a several perks, where each of the perks has an associated credit value, receiving one of more perk selections from the user where the one or more perk selections have a combined credit value, verifying that the combined credit value of the one or more perk selections does not exceed the quantity of perk credits issued to the user, associating the one or more perk selections with the unique user id, deducting the combined credit value from the quantity of perk credits and associating any remaining quantity of perk credits with the unique user id and storing the remaining quantity of perk credits and the one or more perk selections with the unique user id. There is also provided, the above mentioned method where the step of verifying the combined credit value of the one or more perk selections does not exceed the quantity of perk credits issued to the user further includes verifying that the user has made any required perk selections.

In accordance with still another embodiment of the present invention, provided in the practice of the invention is a method for providing employees with amenities administered by an employer organization. The method of this embodiment includes the steps of; providing a quantity of perk credits to a user having a unique user id, presenting several perks to the user, where each of the plurality of perks is associated with a fee, receiving one or more perk selections from the user, where each of the one or more perk selections includes at least one perk from the plurality of perks, calculating a selected perk fee by combining the fees associated with the one or more perks, verifying the selected perk fee does not exceed the quantity of perk credits provided to the user, associating the one or more perk selections with the unique user id, and storing the one or more perk selections with the unique user id. There is further provided in the practice of the invention, the above mentioned method where the step of verifying the selected perk fee does not exceed the quantity of perk credits provided to the user further includes verifying the one or more perk selections include all required perk selections.

In accordance with one aspect of the present invention, is a method for providing employees with amenities administered by an employer organization, including the steps of: providing a quantity of perk credits to a user having a unique user id, presenting several perks to the user, where each of the plurality of perks is associated with a fee, receiving one or more perk selections from the user, where each of the one or more perk selections includes at least one perk from the plurality of perks, combining the fees associated with the one or more perk selections to determine a selected perk fee, and storing the one or more perk selections with the unique user id if the selected perk fee does not exceed the quantity of perk credits provided to the user.

In accordance with another aspect of the present invention is a method for providing employees with amenities administered by an employer; organization, which includes the steps of: providing a quantity of perk credits to a user having a unique user id, presenting several perks to the user, each of the plurality of perks is associated with a fee, and where at least one of the several perks is required, receiving one or more perk selections from the user, where each of the one or more perk selections includes at least one perk from the plurality of perks, combining the fees associated with the one or more perk selections to determine a selected perk fee, and storing the one or more perk selections with the unique user id, if the selected perk fee does not exceed the quantity of perk credits and at least one of the one or more perk selections includes the required perk.

In accordance with yet another aspect of the present invention, a method for providing employees with amenities is administered by an employer organization, and includes the steps of: providing a quantity of perk credits to a user, wherein the user has a unique user id and a user work location, displaying a list of relevant perks to the user, wherein each of the relevant perks is available at the user work location, receiving one or more perk selections from the user, wherein each of the one or more perk selections includes at least one perk from the list of relevant perks, combining any fees associated with each of the one or more perk selections to determine a selected perk fee, and storing the one or more perk selections with the unique user id if the selected perk fee does not exceed the quantity of perk credits.

Certain embodiments and aspects of the invention are outlined above in order that the detailed description thereof may be better understood, and in order that the present contributions to the art may be better appreciated. In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE SEVERAL VIEWS OF THE DRAWING

Further features of the present invention will become apparent to those skilled in the art to which the present invention, relates from reading the following description with reference to the accompanying drawings, in which;

FIG. 1 is a block diagram illustrating a functional implementation of a system for allocation of perks according to an embodiment of the inventive method and system.

FIG. 2 is a block diagram showing several exemplary perk options presented to users according to an embodiment of the inventive method and system.

FIG. 3 is a block diagram showing several exemplary perk options presented to users in an alternative format according to an embodiment of the inventive method and system.

FIGS. 4A & B shows a form interface for user selection of perk options according to an embodiment of the inventive method and system.

FIG. 5 shows an Interface for presenting perk options to users in accordance with an embodiment of the inventive system and method.

FIG. 6 shows a browser-based selection summary interface in accordance with an embodiment of the inventive system and method.

FIG. 7 shows a confirmation screen showing a list of perk options that have been selected in accordance with an embodiment of the inventive system and method.

FIG. 8 shows an email confirmation message in accordance with an embodiment of the inventive system and method.

FIG. 9 shows a perk usage interface with historical and pending status indicators in accordance with an embodiment of the inventive system and method.

FIG. 10 shows an exemplary data record for storage and reporting user selected perk options in accordance with an embodiment of the inventive system and method.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the Figures.

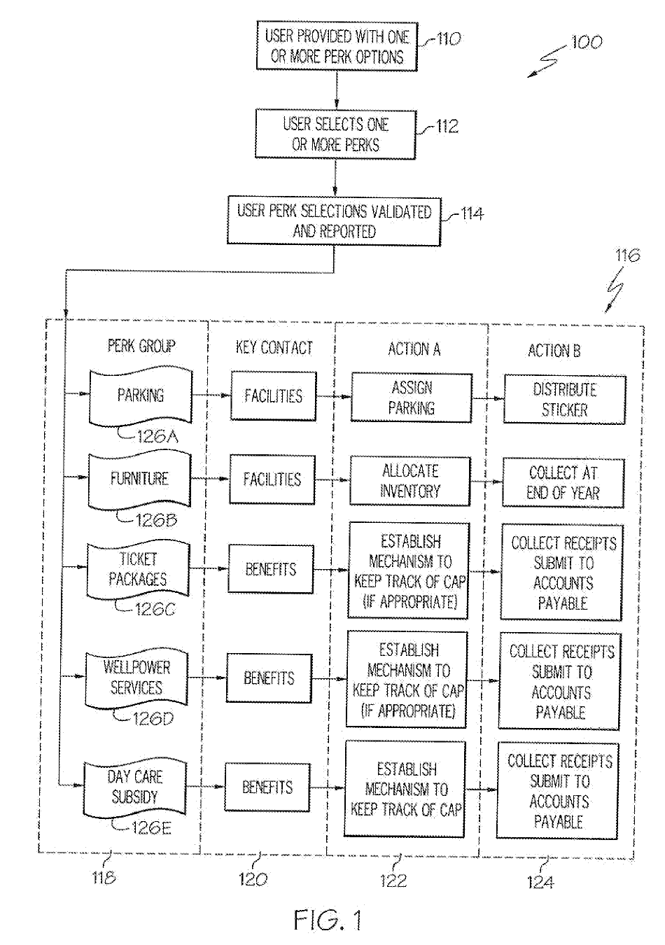

FIG. 1 illustrates an overview of the operation of a system 100 for providing user selectable perks according to an embodiment of the inventive method and system. In block 110, a user is provided with one or more perk options for section. In block 112, the user makes one or more perk selections. In block 114, the user's perk selections are validated then stored by the system. It will be appreciated the user may be an employee and/or associate of the company/employer.

The user's perk selections are reported to a processing module 116 and processed according to perk group type 118. Each perk group 118 is associated with a key contact 120 for fulfillment of the user's perk selection by performing one or more actions (122 & 124). Examples of key contact 120 may include a department within the sponsoring company or an external vendor.

By way of example, a user selected “preferred” parking perk is reported to processing module 116. The processing module 116 determines that the “preferred” parking perk belongs to the parking perk group 118A. Next notification is sent to the key contact 120 that is associated with the parking perk group 118A. In this case, the facilities key contact 120A is contacted to perform the assign parking 122A and distribute sticker 124A actions.

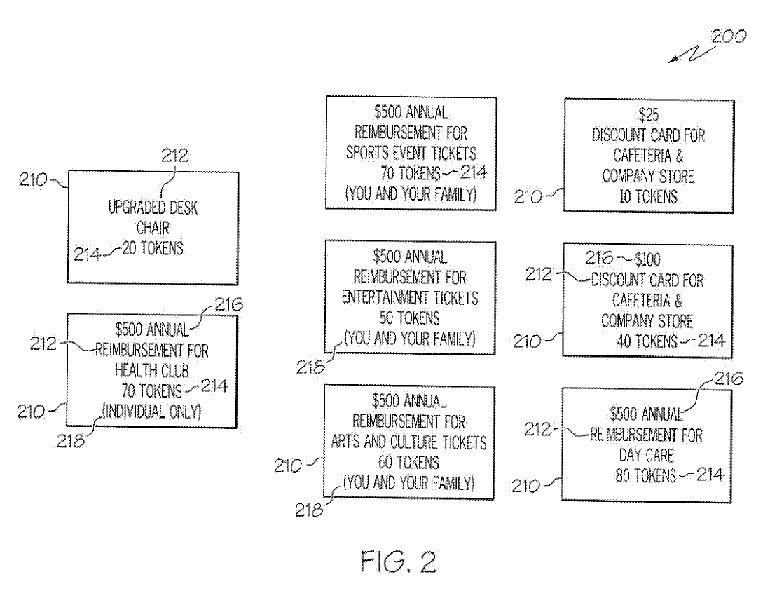

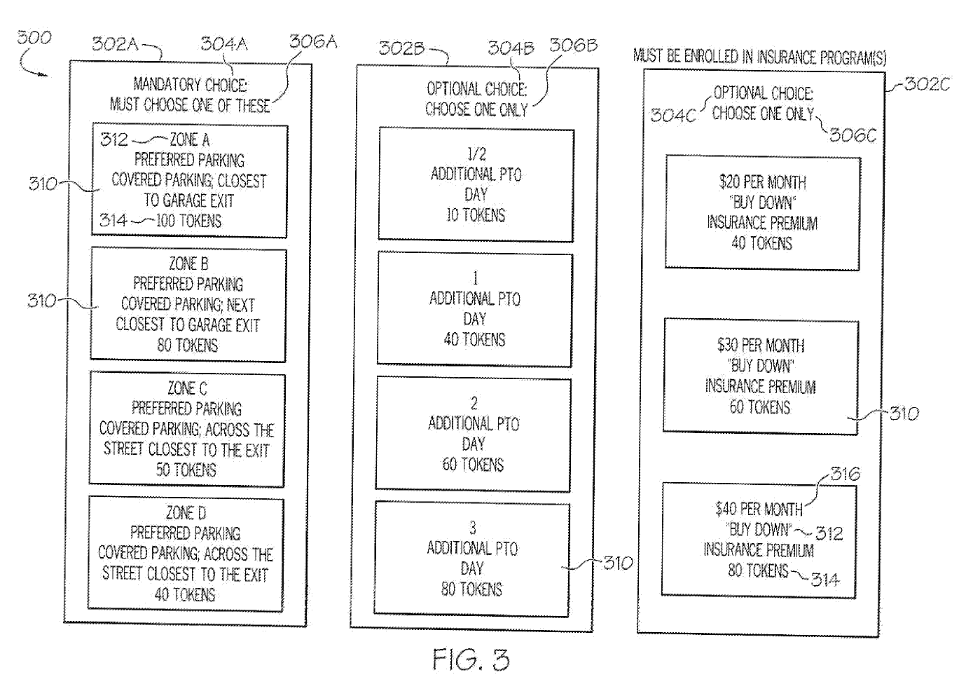

Turning to FIG. 2, shown are several exemplary perk options depicted in a format that may be presented to users according to an embodiment of the inventive method and system. Multiple perk options 200 are illustrated. As shown, each perk option 210 includes a perk title 212 and an associated credit cost 214. Perk option 210A for an “upgraded desk chair” 212A has a credit cost of 20 tokens 214A. Credit cost 214 maybe expressed in any format provided that a user is allocated credits in the same or compatible format.

Some perk options 210 include additional information such as a stated cash value 216 and any applicable restrictions 218. For example, perk option 210B entitled “Reimbursement for Health Club” 212B is available for user selection at credit cost of 70 tokens 214B. Perk option 210B has a $500 annual cash value for up to $500 annual reimbursement for health club fees. It will also be noted that perk option 210B includes an individual only restriction 218B.

Given that it is desirable to present users with relevant perk options, it will be appreciated by one of skill in the art some embodiments of the inventive method and system may associate perk options with additional information (not made visible to the user) and that this additional information can be used ensure that a user is only presented with perk options that are relevant and available to that user. For example, according to one embodiment of the invention, each perk option is associated with a “location id.” The “location id” is used limit the perk options that are presented to the user so that only perk options that are relevant and available to that user, by presenting a perk option to a user only if the user id is associated with a “work location id” that matches the “location id” associated with the perk option. This way, a DC based employee will be presented with perk options that are relevant and available to that user (such as pre-tax reimbursement for the metro subway) and not presented with a perk option for a discount membership at fitness center located near the company headquarters in Kansas City.

Turning now to FIG. 3, a system 300 featuring groups of perk options with various levels of participation is depicted In block form. As shown, system 300 Includes several groups of perk options 302A, 302B, and 302C. Each group of perk options 302A includes a first instruction 304A which indicates whether or not it is mandatory for a user to make a selection from among the perk options 310 of group 302A. Each group of perk options 302A further includes a second instruction 306A to provide a user with additional information. For group 302A, instructions 304A and 306A inform a user that a selection of one of tire perk options 310 in the group 302A Is required. As was described with reference to FIG. 2, each perk option 310 includes a title 312 and a credit cost 314.

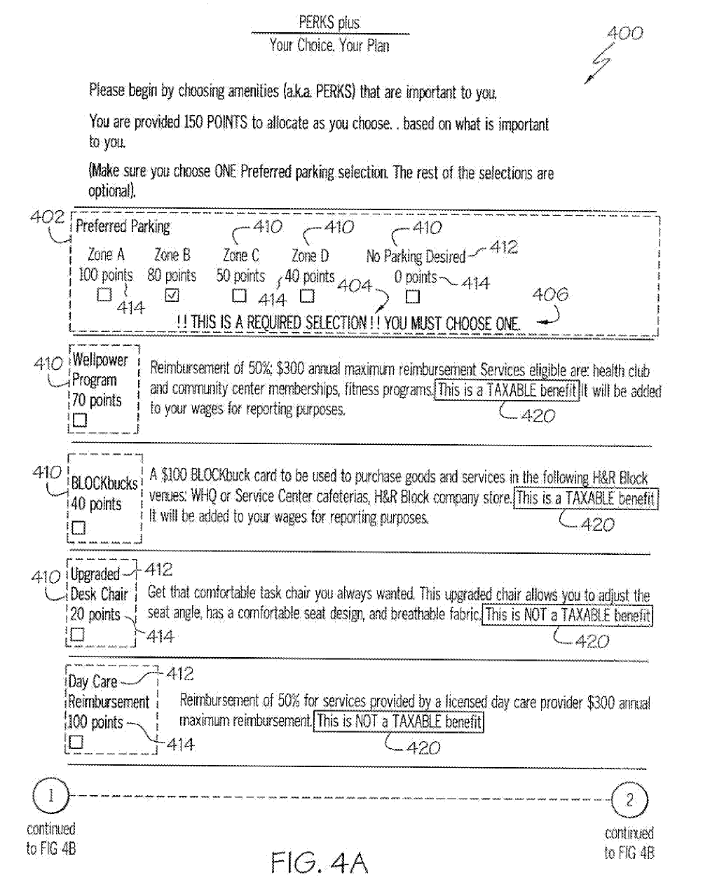

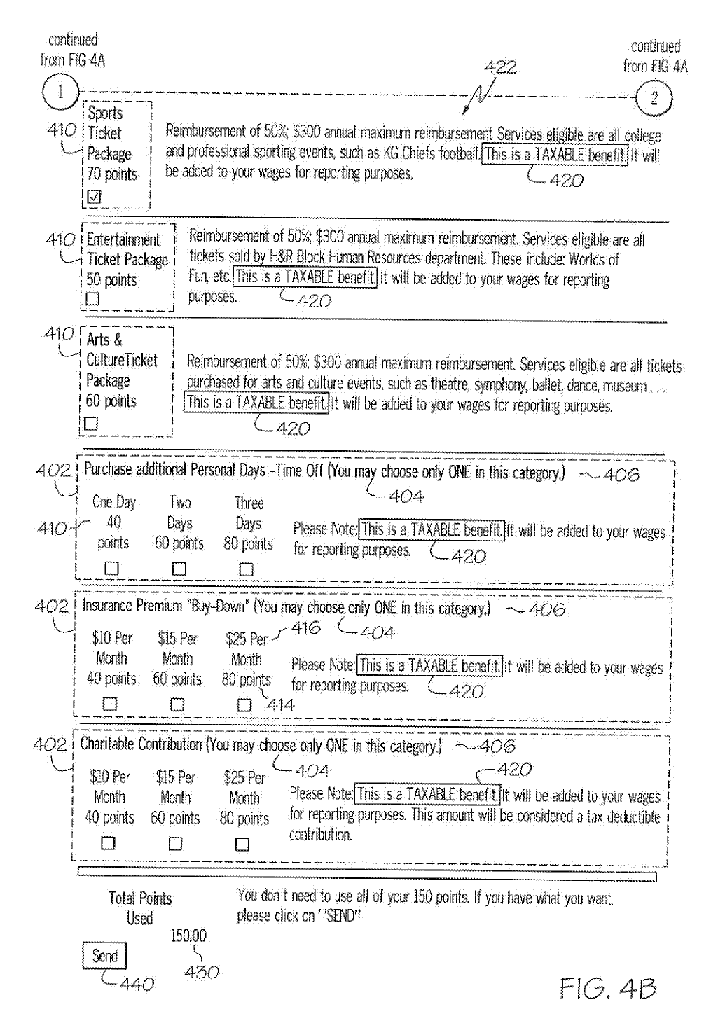

FIGS. 4A & B show a form interface for user selection of perk options according to an embodiment of the inventive method and system. Form 400 includes general user instructions and groups of perk options 402 where each perk option in the group 402 represents a different level of participation. In “Preferred Parking” group 402, instruction 404 instructs the user that a selection is required. Second instruction 406 indicates that the user must choose one of the perk options 410 in the “Preferred Parking” group of perk options 402. As was described with respect to FIGS. 2 and 3, each perk option 410 includes a title 412 and a credit cost 414.

According to another embodiment of the present invention, the system shows “Preferred Parking” perk options where the “Preferred Parking” location id matches the location id of the user. In FIG. 4A, perk options 410 include a tax status indicator 420. For example, the tax status indicator 420 indicates that perk option 410 entitled “Wellpower Program” is a taxable benefit. On the other hand, the tax status indicator 420 indicates that the perk option 410 entitled “Upgraded Desk Chair” is not a taxable benefit.

Turning to FIG. 4B, form 400 includes a used points total 430 which provides the user with a running total credit cost for the perk options the user has selected. Button 440 is used to send a user's selected perk options for storage in a data repository.

One of skill in the art will appreciate that it may be desirable to perform validation of user selections and that validation of user selections may be implemented in a browser based form. User selection validation parameters may ensure check that the combined price of user selected perks does not exceed a user's allotted perk credits. When one or more perks selections are mandatory or required, it is desirable to perform the step or validating a user's perk selections to ensure that a user has made all mandatory/required perk selections,

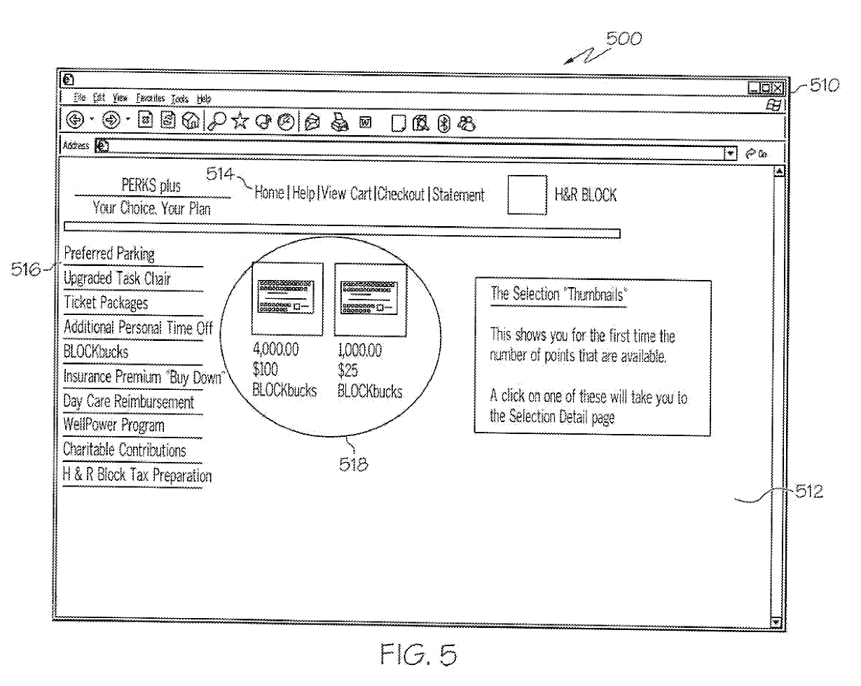

FIG. 5 shows an interface for presenting perk options to users in accordance with an embodiment of the inventive system and method. System 500 includes a browser 510 used to access an online system for presenting perk options to a user which includes a web page interface 512. Web page interlace 512 includes one or more system navigation links 514 and perk option navigation items 516. As shown, the “Blockbucks” perk navigation item 516 has been selected and selection thumbnails 518 are displayed on the web page interface in a location that is left of the perk option navigation items 516.

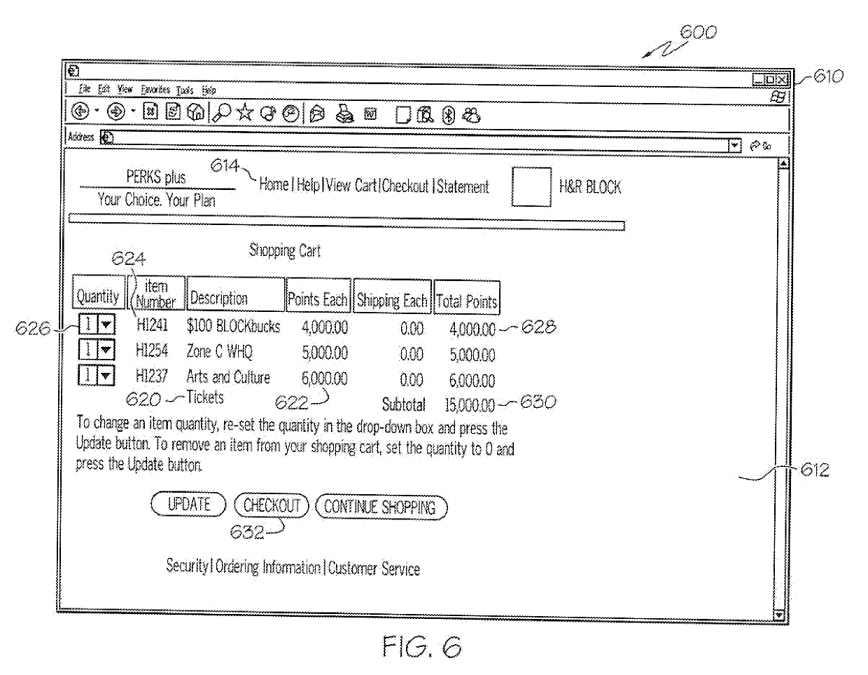

FIG. 6 shows a browser-based selection summary interface in accordance with art embodiment of the inventive system and method. Browser 600 shows a browser 610 displaying a selection summary interface 612. It will be appreciated by one of skill in the art that selection summary interface 612 concept will likely be familiar to the user as it is analogous to a shopping cart commonly used by online retailers. Selection summary interface 612 includes one or more system navigation links 614. Features of the summary include the title 620 of one of more perk options selected by the user. Additional perk option information is also shown including the associated credit cost 622, perk option id number 624, quantity of selected perk options 626, line item subtotal 628, and total credit cost for all selected perk options 630. Finally, checkout button 632 stores and sends the user's selected perk options for fulfillment.

As previously mentioned it may be desirable to perform one or more types of validation prior storage and reporting a user's selected perk options for fulfillment. One of skill in the art will appreciate that basic browser form validation may be implemented and carried out on a client machine. Form validation parameters may verify that the combined cost for all user selected perks does not exceed a user's allotted perk credits. When one or more perks selections are mandatory or required, it is desirable to perform the step or validating a user's perk selections to ensure that a user has made all mandatory/required perk selections.

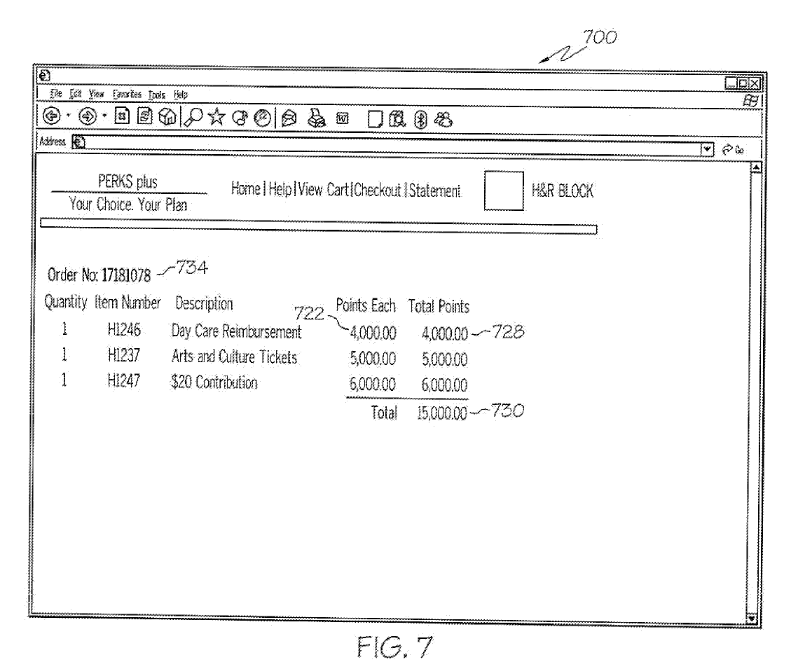

FIG. 7 shows a confirmation screen showing a list of perk options that have been selected in accordance with an embodiment of the inventive system and method. Item 700 shows a confirmation statement. Features of the confirmation statement 700 include the title of one of more perk options selected by the user the associated credit cost 722, perk option id number, quantity of selected perk options, line item subtotal 728, and total credit cost for all selected perk options 730. Finally, an order reference number 734 is provided.

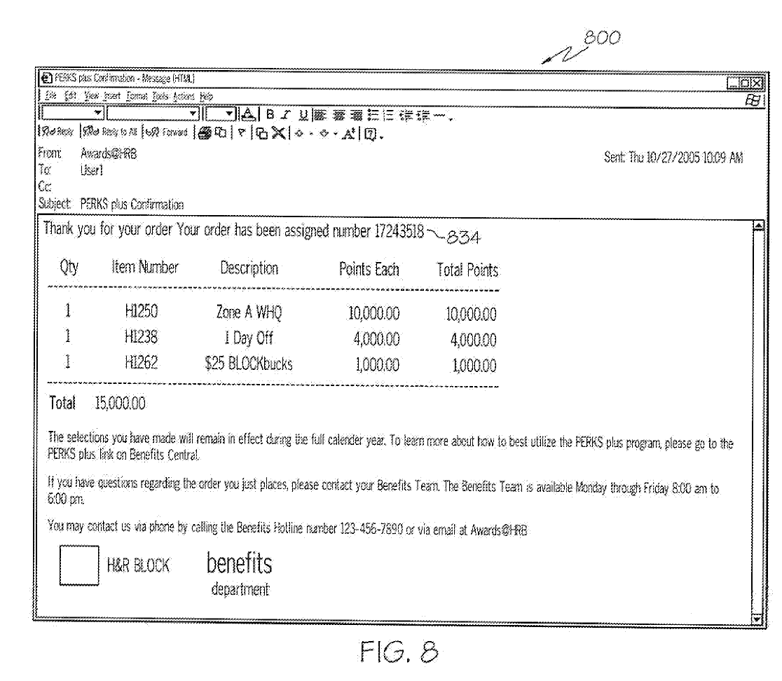

FIG. 8 shows an email confirmation, message in accordance with an embodiment of the inventive system and method. Item 800 shows an email confirmation message. An email confirmation message is sent to the user via a user provided email address. All features of the confirmation statement of FIG. 7 are also present in email confirmation message 800.

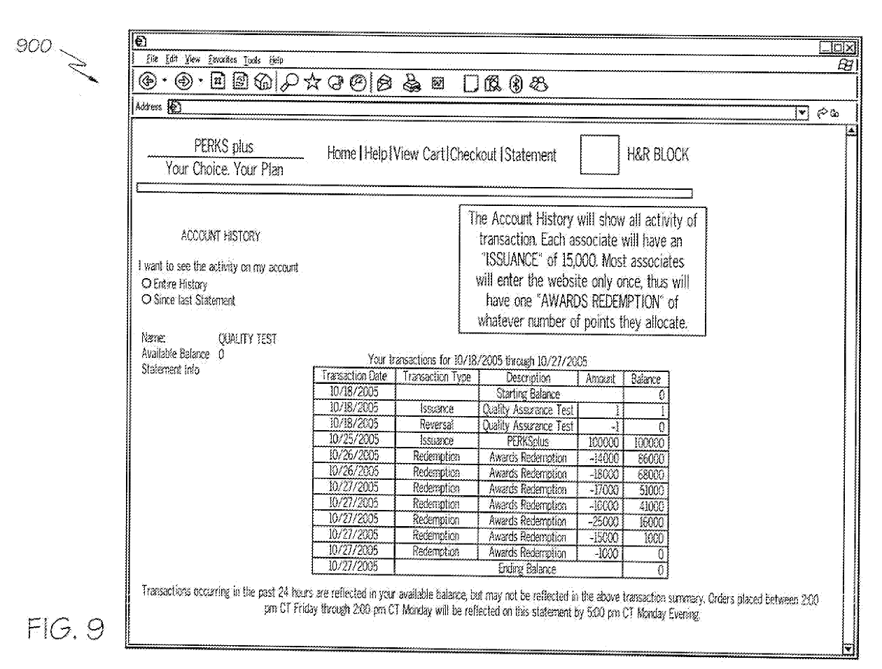

FIG. 9 shows a perk usage interface with historical and pending status indicators in accordance with an embodiment of the inventive system and method.

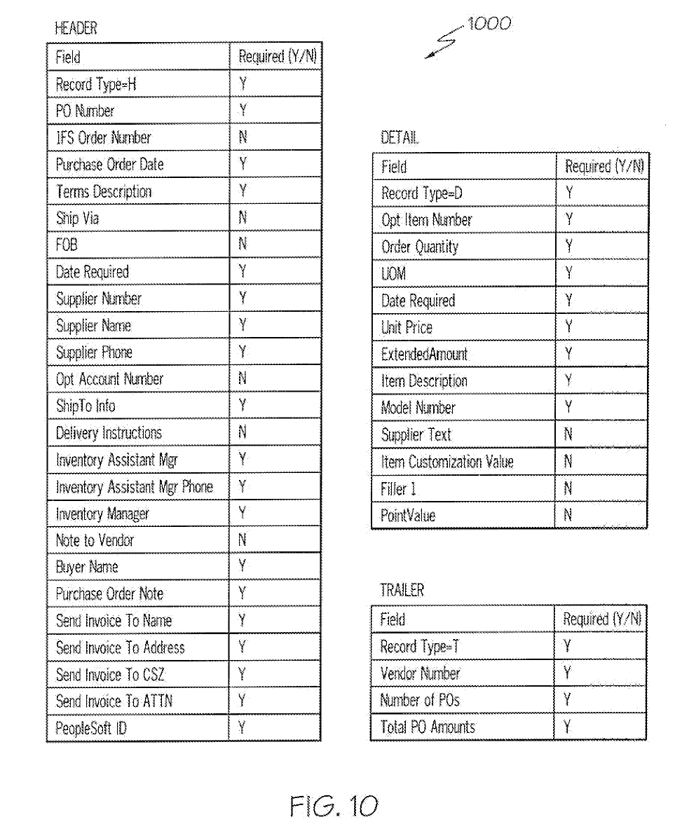

FIG. 10 shows an exemplary data record for storage and reporting user selected perk options in accordance with an embodiment of the inventive system and method.

It will be appreciated that the terms perks and amenities are generally understood to be synonymous. It will further be appreciated that as described herein, the terms employee and associate have been used interchangeably.

One of ordinary skill in the art will appreciate that processes in accordance with the teachings of the present invention are capable of being performed and distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for providing employees with amenities administered by an employer organization, comprising the steps of:
issuing a quantity of perk credits to a user wherein said user has a unique user id;
presenting said user with a plurality of perks, wherein each of said plurality of perks has an associated credit value;
receiving one or more perk selections from said user wherein each of said one or more perk selections has a credit value;
determining a combined credit value for all of said perk selections;
verifying said combined credit value does not exceed said quantity of perk credits issued to said user;
associating said one or more perk selections with said unique user id;
deducting said combined credit value from said quantity of perk credits and associating any remaining quantity of perk credits with said unique user id; and
storing said remaining quantity of perk credits and said one or more perk selections with said unique user id.

2. The method of claim 1 further comprising the step of providing a list comprising said one or more perk selections associated with said unique user id.

3. The method of claim 1 wherein the step of verifying said combined credit value of said one or more perk selections does not exceed said quantity of perk credits issued to said user further comprises verifying said user has made any required perk selections.

4. The method of claim 1 further comprising the step of notifying a designated employer representative.

5. The method of claim 1 further comprising the step of generating an order for at least one of said perk selections and sending said order to a vendor for fulfillment.

6. The method of claim 5 further comprising the step of sending a copy of said order to a designated employer representative.

7. A computer-readable medium having computer-executable instructions for performing the steps recited in claim 1.

8. A computer readable storage medium having stored thereon a computer program for implementing a method for providing employees with amenities administered by an employer organization, comprising the steps of:
issuing a quantity of credits to a user;
providing a list of perk items to said user for selection, wherein each perk item has an associated credit value;
receiving input from said user wherein said input comprises one or more perk items selected by said user;
calculating a total credit value for said one or more perk items selected by said user;
verifying said total credit value for said one or more perk items selected by said user does not exceed said quantity of credits issued to said user; and
associating said one or more perk selections with said user.

9. The computer-implemented method, as recited in claim 8, further comprising the step of verifying said user has made all required perk selections.

10. The computer-implemented method, as recited in claim 8, further comprising the step of deducting said total credit value from said quantity of credits and associating any remaining quantity of credits with a user data record.

11. The computer-implemented method, as recited in claim 10, further comprising the step of storing said remaining quantity of credits and said one or more perk selections with said user record.

12. The computer-implemented method, as recited in claim 8, further comprising the step of notifying a designated employer representative of said user selection of one or more perks.

13. The computer-implemented method, as recited in claim 8, further comprising the step of generating an order for at least one of said perk selections and sending said order to a vendor for fulfillment.

14. The computer-implemented method, as recited in claim 13, further comprising the step of sending a copy of said order to a designated employer representative.

15. A method for providing employees with amenities administered by an employer organization, comprising the steps of;
providing a quantity of perk credits to a user having a unique user id;
presenting a plurality of perks to said user, wherein each of said plurality of perks is associated with a fee;
receiving one or more perk selections from said user, wherein each of said one or more perk selections includes at least one perk from said plurality of perks;
calculating a selected perk, fee by combining said fees associated with said one or more perks;
verifying said selected perk fee does not exceed said quantity of perk credits provided to said user; and
associating said one or more perk selections with said unique user id.

16. The method of claim 15 wherein the step of verifying said selected perk fee does not exceed said quantity of perk credits provided to said user further comprises verifying said one or more perk selections include all required perk selections.

17. A method for providing employees with amenities administered by an employer organization, comprising the steps of;
providing a quantity of perk credits to a user, wherein said user has a unique user id and a user work location;
displaying a list of relevant perks to said user, wherein each of said relevant perks is available at said user work location;
receiving one or more perk selections from said user, wherein each of said one or more perk selections includes at least one perk from said list, of relevant perks;
combining any fees associated with each of said one or more perk selections to determine a selected perk fee; and
storing said one or more perk selections with said unique user id if said selected perk fee does not exceed said quantity of perk credits.

18. The method of claim 17 further comprising the step of verifying said user has made all required perk selections.

19. The method of claim 17 further comprising the step of deducting said selected perk fee from said quantity of perk credits and associating any remaining quantity of perk credits with said unique user id.

20. The method of claim 17 further comprising the step of storing said remaining quantity of perk credits and said one or more perk selections with said unique user id.

21. The method of claim 17 further comprising the step of notifying a designated employer representative of said perk selections.

22. The method of claim 17 further comprising the step of generating an order for at least one of said perk selections and sending said order to a vendor for fulfillment.

23. The method of claim 22 further comprising the step of sending a copy of said order to a designated employer representative.

24. A computer-readable medium having computer-executable instructions for performing the steps recited in claim 17.
